(19) United States
(12) Patent Application Publication
(10) Pub. No.: US 2026/0057847 A1
(43) Pub. Date: Feb. 26, 2026

(54) Display Driver Integrated Circuit with a Power-Conserving Configuration

(71) Applicant: Google LLC, Mountain View, CA (US)

(72) Inventors: Weihsiang Hung, Taipei City (TW); Sangmoo Choi, Palo Alto, CA (US)

(73) Assignee: Google LLC, Mountain View, CA (US)

(21) Appl. No.: 19/313,137

(22) Filed: Aug. 28, 2025

Related U.S. Application Data
(60) Provisional application No. 63/865,883, filed on Aug. 18, 2025.

(51) Int. Cl. G09G 3/3275

(52) U.S. Cl. CPC G09G 3/3275; G09G 2310/0297; G09G 2310/08; G09G 2330/023; G09G 2340/0435

(57) ABSTRACT

Techniques and apparatuses are described that implement a display driver integrated circuit with a power-conserving configuration. In an example aspect, a display module of a device includes a display driver integrated circuit that can control operations of multiple channels within a display panel of the display module. The display driver integrated circuit can operate in different configurations as a refresh rate of the display panel changes over time. At least one of these configurations includes a power-conserving configuration, which disables a subset of amplifiers to conserve power. The display driver integrated circuit includes driver switching circuitry that can route display data for two or more different channels of the display panel to one of the amplifiers that is enabled during the power-conserving configuration. In this way, the display driver integrated circuit can conserve power by operating with fewer amplifiers while supporting some refresh rates of the display panel.

### CROSS-REFERENCE TO RELATED APPLICATION

This application claims the benefit of U.S. Provisional Patent Application Ser. No. 63/865,883 filed on Aug. 18, 2025, the disclosure of which is incorporated by reference herein in its entirety.

### BACKGROUND

Electronic devices can provide a variety of features and functionality that make everyday life easier for users. Some features, however, can strain the electronic device's power resources, thereby reducing a duration of mobile operation or causing the electronic device to be recharged more often. As limitations on available power can significantly impact the utilization of electronic devices, there is an increased demand for designing components of an electronic device that consume less power and reduce overall power consumption of the electronic device.

### SUMMARY

Techniques and apparatuses are described that can be used to implement a display driver integrated circuit with a power-conserving configuration. In an example aspect, a display module of a device includes a display driver integrated circuit that can control operations of multiple channels within a display panel of the display module. The display driver integrated circuit can operate in different configurations as a refresh rate of the display panel changes over time. At least one of these configurations includes a power-conserving configuration, which disables a subset of amplifiers within the display driver integrated circuit to conserve power. The display driver integrated circuit includes driver switching circuitry that can route display data for two or more different channels of the display panel to one of the amplifiers that is enabled during the power-conserving configuration. In this way, the display driver integrated circuit can conserve power by operating with fewer amplifiers while supporting some refresh rates of the display panel.

Aspects described below include an apparatus with a display driver integrated circuit. The display driver integrated circuit is configured to be coupled to a display panel. The display panel is capable of supporting different refresh rates. The different refresh rates include at least a standard refresh rate and a first power-efficient refresh rate. The first power-efficient refresh rate is less than the standard refresh rate. The display driver integrated circuit is also configured to operate in a first configuration based on the display panel having the standard refresh rate. While in the first configuration, the display driver integrated circuit is configured to generate at least two display signals using at least two amplifiers. The at least two display signals include different display data associated with different channels of the display panel. The display driver integrated circuit is also configured to operate in a second configuration based on the display panel having the first power-efficient refresh rate. While in the second configuration, the display driver integrated circuit is configured to generate a first display signal of the at least two display signals using a first amplifier of the at least two amplifiers. The first display signal comprises the different display data associated with the different channels.

Aspects described below also include a method for operating a display driver integrated circuit in a power-conserving configuration.

Aspects described below include a computer program product comprising computer-executable instructions that, when executed by a computing device, cause a display driver integrated circuit to operate in a power-conserving configuration.

Aspects described below also include a system with means for operating a display driver integrated circuit in a power-conserving configuration.

### BRIEF DESCRIPTION OF DRAWINGS

Apparatuses and techniques for implementing a display driver integrated circuit with a power-conserving configuration are described with reference to the following drawings. The same numbers are used throughout the drawings to reference like features and components:

FIG. 1 illustrates an example implementation of a computing device with a display driver integrated circuit that can operate in a power-conserving configuration;

FIG. 2 illustrates an example implementation of a display module with a display driver integrated circuit that can operate in a power-conserving configuration;

FIG. 3-1 illustrates a first example implementation of driver switching circuitry of a display driver integrated circuit;

FIG. 3-2 illustrates a second example implementation of driver switching circuitry of a display driver integrated circuit;

FIG. 4 illustrates a first example timing diagram for operating a display driver integrated circuit in a first configuration based on a display panel having a first refresh rate;

FIG. 5 illustrates a second example timing diagram for operating a display driver integrated circuit in a second configuration based on a display panel having a second refresh rate;

FIG. 6 illustrates a third example timing diagram for operating a display driver integrated circuit in a third configuration based on a display panel having a third refresh rate; and

FIG. 7 illustrates a fourth example timing diagram for operating a display driver integrated circuit in a fourth configuration based on a display panel having a fourth refresh rate.

### DETAILED DESCRIPTION

To improve a user's experience, some devices support an “always-on” display (AOD) feature. Instead of having a static lock screen on a device, the “always-on” display can provide an interactive, informative, and stylish screen when the device is in a locked state. With the “always-on” display, a user can receive notifications, view a calendar or a memo, receive information regarding missed calls, reference a digital clock, or control the playback of music. While the “always-on” display can provide many conveniences for a user, it can significantly decrease a usage time of the device due to the amount of power that is consumed via the display.

To increase power efficiency while operating a display, techniques are described that implement a display driver integrated circuit with a power-conserving configuration. In an example aspect, a display module of a device includes a display panel that can present visual information to a user of the device and a display driver integrated circuit that can control operations of multiple channels within the display panel. The display panel can operate at different refresh rates to adjust power consumption based on usage of the device. The display driver integrated circuit can operate in different configurations as the refresh rate of the display panel changes over time. At least one of these configurations includes a power-conserving configuration, which disables a subset (e.g., a proper subset) of amplifiers within the display driver integrated circuit to conserve power. The display driver integrated circuit includes driver switching circuitry that can route display data for two or more different channels of the display panel to one of the amplifiers that is enabled during the power-conserving configuration. In this way, the display driver integrated circuit can conserve power by operating with fewer amplifiers while supporting some refresh rates of the display panel.

Display Driver Integrated Circuit with a Power-Conserving Configuration

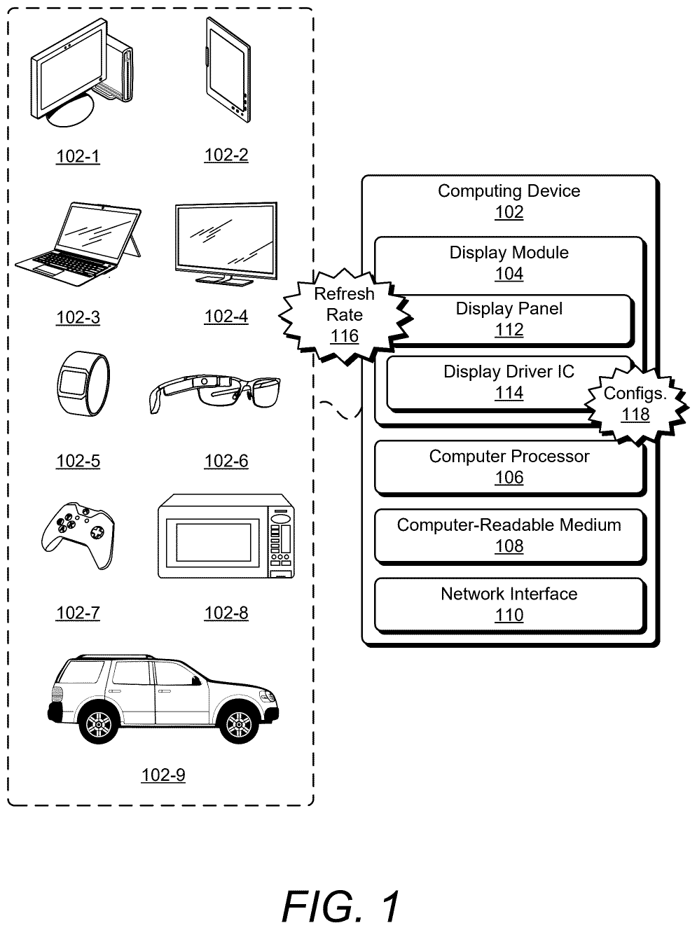

FIG. 1 illustrates an example computing device 102. The computing device 102 is illustrated with various non-limiting example devices, including a desktop computer 102-1, a tablet 102-2, a laptop 102-3, a television 102-4, a computing watch 102-5, computing glasses 102-6, a gaming system 102-7, a microwave 102-8, and a vehicle 102-9. Other devices may also be used, including a home service device, a smart thermostat, a drawing pad, a netbook, an e-reader, a home automation and control system, a wall display, or another home appliance. Note that the computing device 102 can be wearable, non-wearable but mobile, or relatively immobile (e.g., desktops and appliances).

In the depicted configuration, the computing device 102 includes at least one display module 104, at least one computer processor 106, at least one computer-readable medium 108 (e.g., non-transitory computer-readable medium), and at least one network interface 110. The computer-readable medium 108 can include memory media and/or non-transitory storage media. Applications and/or an operating system (not shown) embodied as computer-readable instructions on the computer-readable medium 108 can be executed by the computer processor 106 to provide some of the functionalities described herein. The network interface 110 can communicate data over wired, wireless, or optical networks. For example, the network interface 110 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, Bluetooth®, and the like.

The display module 104 includes at least one display panel 112 and at least one display driver integrated circuit (DDIC) 114 (display driver IC 114). The display panel 112 is an electronic screen that can present visual information to a user of the computing device 102. The display panel 112 can be built using organic light emitting diode (OLED) technology. In this case, the display panel 112 can be referred to as an OLED display. In some implementations, the display module 104 has an “always-on” display feature.

The performance and power consumption of the display panel 112 is based, at least in part, on a refresh rate 116 at which it operates. The refresh rate 116 represents a frequency at which the display panel 112 updates a displayed image. In other words, it determines a quantity of images that are presented via the display panel 112 per second. The display panel 112 can selectively operate at different refresh rates 116 over time depending on usage of the computing device 102. With a higher refresh rate 116, the display panel 112 can provide a better user experience by presenting a smoother video and reducing strain on the user's eyes at the cost of consuming additional power. With a lower refresh rate 116, the display panel 112 can conserve power at the cost of providing a less smooth video. If the user is playing a game on the computing device 102 or watching a high-resolution video, the display panel 112 can operate at the higher refresh rate 116 to provide a better user experience. During mobile operation or for less visually-demanding applications (e.g., browsing email, editing a document, or making a phone call), the display panel 112 can operate at a lower refresh rate 116 to conserve power.

The highest refresh rate 116 of the multiple refresh rates 116 is referred to as a “standard” refresh rate or a “normal” refresh rate. In an example implementation, the standard refresh rate is equal to 120 hertz (Hz). Other ones of the multiple refresh rates 116 can represent power-efficient refresh rates, which are less than the standard refresh rate. In some implementations, the power-efficient refresh rates are equal to the standard refresh rate divided by some integer power of two (e.g., 2, 4, 8, 16, or 64). For instance, a first power-efficient refresh rate can be equal to half of the standard refresh rate and a second power-efficient refresh rate can be equal to a fourth of the standard refresh rate. If the standard refresh rate is 120 hertz, example power-efficient refresh rates can be 60 hertz, 30 hertz, or 1 hertz. Other standard refresh rates and power-efficient refresh rates are also possible.

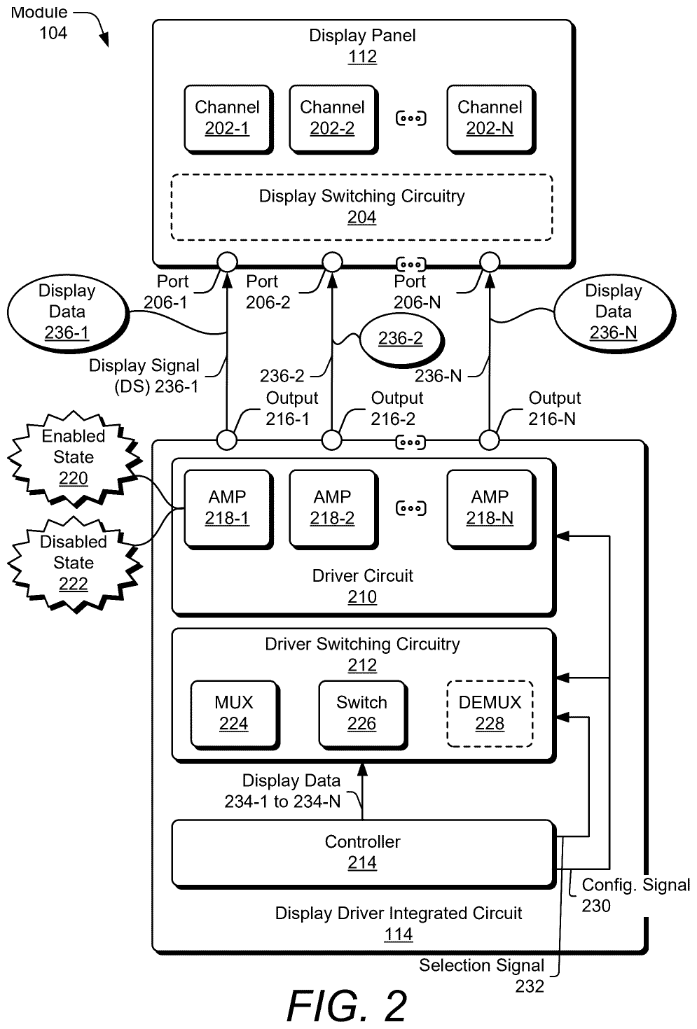

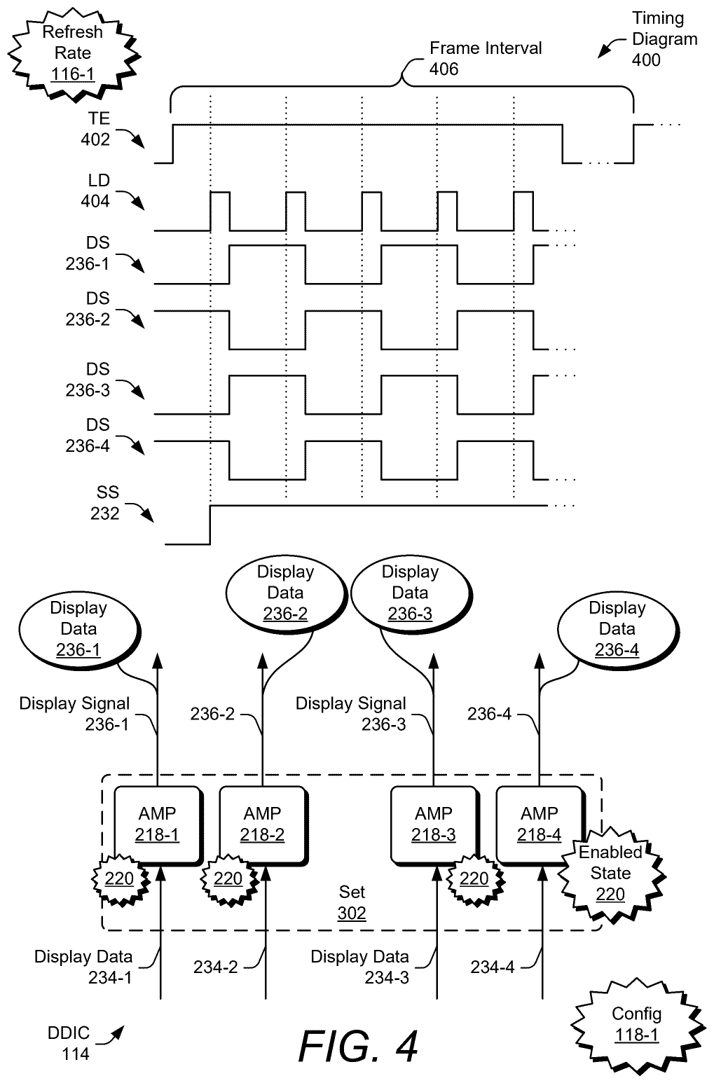

The display driver integrated circuit 114 converts digital image data into analog signals that control the pixels within the display panel 112. In more detail, the display driver integrated circuit 114 sends, to the display panel 112, signals that control the brightness and color of pixels within the display panel 112 to form an image. The display driver integrated circuit 114 can operate in multiple configurations 118 over time based on the display panel 112's refresh rate 116 changing over time. Example refresh rates 116 and configurations 118 are further described with respect to FIGS. 4 to 7. The configurations 118 can include a standard configuration and one or more power-conserving configurations. The power-conserving configurations enable the display driver integrated circuit 114 to consume less power, thereby improving a power efficiency of the computing device 102 and extending mobile operation. Example components of the display panel 112 and the display driver integrated circuit 114 are further described with respect to FIG. 2.

FIG. 2 illustrates an example implementation of the display module 104. In the depicted configuration, the display module 104 includes the display panel 112 and the display driver integrated circuit 114. Although not explicitly shown, the display module 104 can include other components such as a gate-on-array (GOA) circuit, an electromagnetic driver, a clock circuit, and/or a power manager. The display panel 112 includes multiple channels 202-1, 202-2 . . . 202-N, where N represents a positive integer that is greater than one. Each channel 202 can include a group of pixels or subpixels. In some example implementations, each group of pixels or subpixels corresponds to a column of the display panel 112. Different channels 202 can also correspond to different colors. For example, channel 202-1 can include red light-emitting diodes, channel 202-2 can include blue light-emitting diodes, and channel 202-N can include green light-emitting diodes.

Optionally, the display panel 112 can include a display switching circuitry 204. The display switching circuitry 204 can be implemented using at least one demultiplexer or using multiple switches. The display panel 112 also includes multiple ports 206-1, 206-2 . . . 206-N. In general, each port 206 is coupled to a corresponding channel 202. For example, a first port 206-1 is coupled to a first channel 202-1. Likewise, an Nth port 206-N is coupled to an Nth channel 202-N. In some example implementations, the display switching circuitry 204 can optionally couple one of the ports 206 to different channels 202 over time. For example, the display switching circuitry 204 can couple the first port 206-1 to the first channel 202-1 during a first time interval and can couple the first port 206-1 to a second channel 202-2 during a second time interval. This enables the display driver integrated circuit 114 to operate in a power-saving configuration, as further described below.

The display driver integrated circuit 114 includes at least one driver circuit 210, driver switching circuitry 212, at least one controller 214, and multiple outputs 216-1, 216-2 . . . 216-N. Each output 216 is coupled to a corresponding port 206 of the display panel 112. For example, a first output 216-1 is coupled to the first port 206-1. Likewise, an Nth output 216-N is coupled to the Nth port 206-N. The driver circuit 210 includes at least two amplifiers 218, such as amplifiers 218-1, 218-2 . . . 218-N. In example implementations, the amplifiers 218 can be implemented as operational amplifiers (OP AMPs). The amplifiers 218 generate the necessary voltage or current signals that control an operation of the channels 202. The driver circuit 210 can alternatively be referred to as a source driver or a data driver.

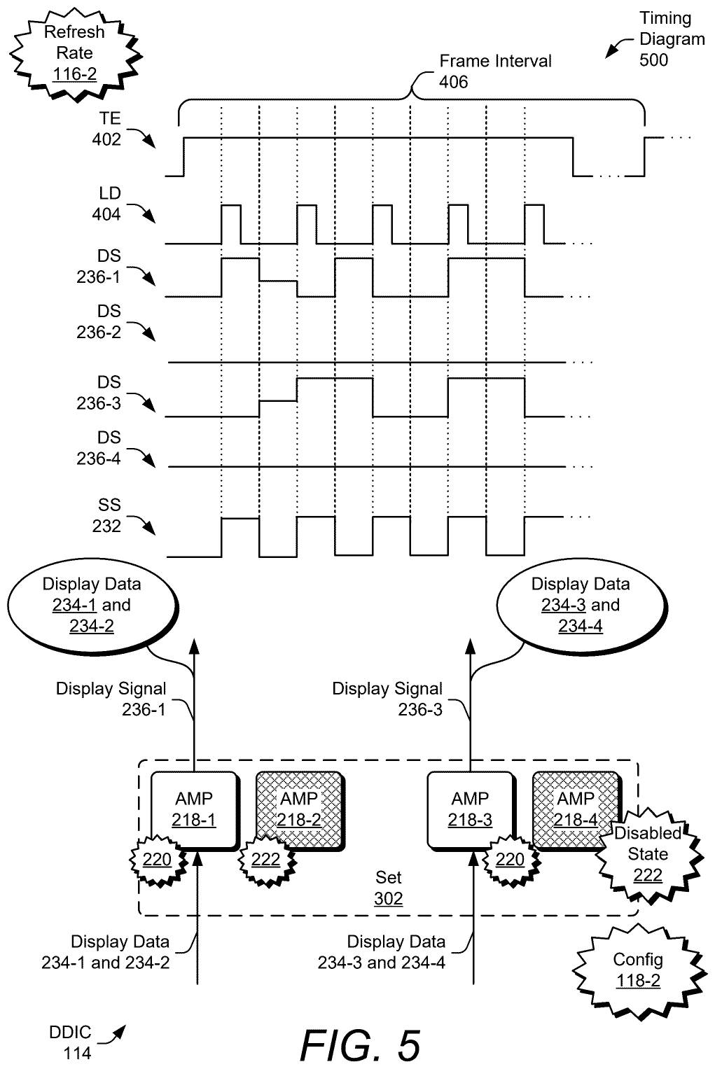

Each amplifier 218 can selectively operate in an enabled state 220 or a disabled state 222. In the enabled state 220, the amplifier 218 consumes a first amount of power to generate a signal that can control an operation of at least one of the channels 202. In the disabled state 222, the amplifier 218 does not generate the signal and consumes a second amount of power that is less than the first amount of power. For the standard configuration, the driver circuit 210 enables all amplifiers 218 within the driver circuit 210 and operate these amplifiers 218 in parallel, as further described with respect to FIG. 4. For a power-conserving configuration, the driver circuit 210 disables a subset of the amplifiers 218 to reduce power consumption of the display driver integrated circuit 114, as further described with respect to FIGS. 5 to 7. In this situation, the subset of amplifiers 218 that are in the enabled state generate signals for different channels 202 in a serial manner.

The driver switching circuitry 212 routes information from the controller 214 to the driver circuit 210 for various configurations 118 of the display driver integrated circuit 114. For the standard configuration, the driver switching circuitry 212 enables each amplifier 218 to generate a signal for the corresponding channel 202. In the power-conserving configuration 118, the driver switching circuitry 212 enables one amplifier 218 to generate signals for more than one channel 202.

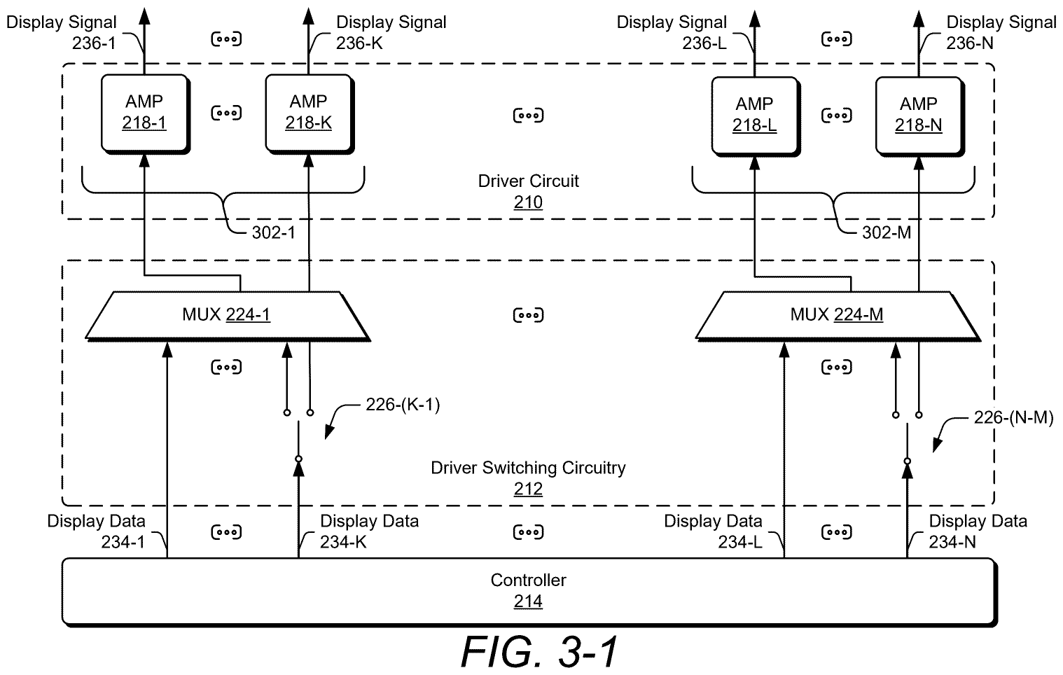

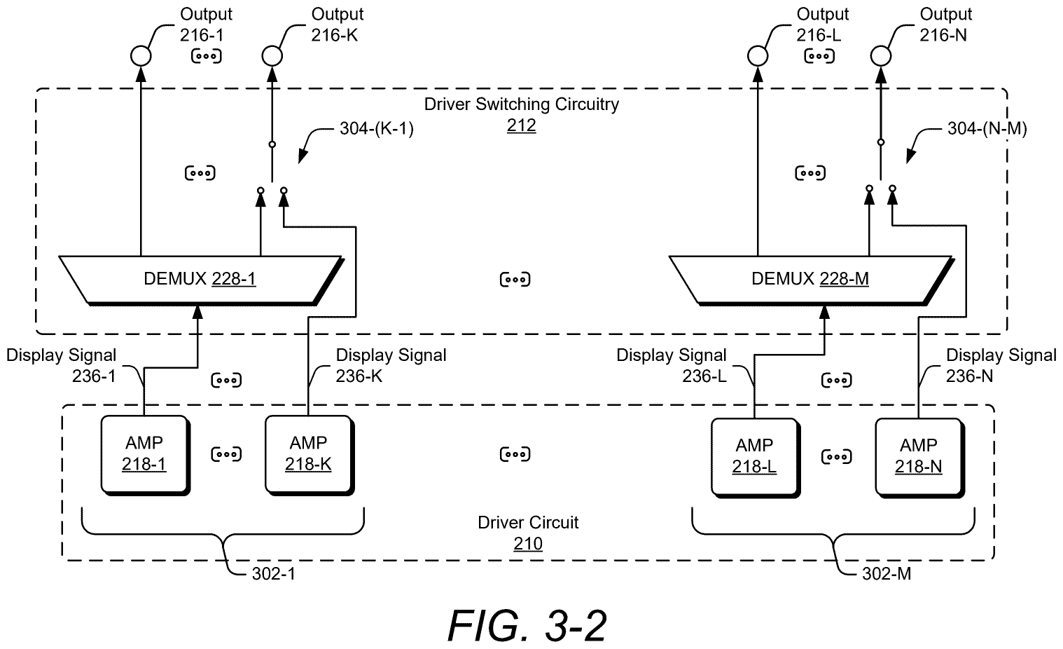

The driver switching circuitry 212 includes at least one multiplexer 224 (MUX 224) and at least one switch 226. In some cases, the driver switching circuitry 212 can include multiple multiplexers 224 and multiple switches 226, as shown in FIG. 3-1. If the display panel 112 does not include the display switching circuitry 204, the driver switching circuitry 212 can also be designed to route signals from the driver circuit 210 to the outputs 216. To perform this, the driver switching circuitry 212 includes at least one demultiplexer 228 (DEMUX 228) and at least once other switch 226. In some cases, the driver switching circuitry 212 includes multiple demultiplexers 228 and multiple other switches 226, as shown in FIG. 3-2. If the display panel 112 includes the display switching circuitry 204, the driver switching circuitry 212 can be implemented without the one or more demultiplexers 228 and without the one or more other switches 226.

During operation, the controller 214 determines a refresh rate 116 of the display panel 112 and determines a configuration 118 of the display driver integrated circuit 114 based on the determined refresh rate 116. For the standard refresh rate, the controller 214 configures the display driver integrated circuit 114 with the standard configuration. For a power-efficient refresh rate, the controller 214 configures the display driver integrated circuit 114 with a corresponding power-conserving configuration. To appropriately configure the display driver integrated circuit 114 based on the determined configuration 118, the controller 214 generates a configuration signal 230, which is provided to the driver switching circuitry 212 and the driver circuit 210. The configuration signal 230 causes a first set of amplifiers 218 to be in the enabled state 220. Additionally or alternatively, the configuration signal 230 causes a second set of amplifiers 218 to be in the disabled state 222. Within the driver switching circuitry 212, the configuration signal 230 determines a configuration of the one or more switches 226.

The controller 214 also generates a selection signal (SS) 232. The selection signal 232 controls which input signal is selected by the one or more multiplexers 224 and controls which output is selected by the one or more demultiplexers 228. Across a frame's duration, the selection signal 232 can cause a multiplexer 224 to route, in a serial manner, multiple types of data from the controller 214 to an amplifier 218 over time. Additionally, the selection signal 232 can cause a demultiplexer 228 to route a signal that is generated by an amplifier 218 to multiple outputs 216 over time. Example selection signals 232 are further described with respect to FIGS. 4 to 7. Although not explicitly shown, some configurations of the display module 104 can pass the selection signal 232 to the display switching circuitry 204. In this case, the selection signal 232 causes the display switching circuitry 204 to route, in a serial manner, a signal that is provided at a port 206 to multiple channels 202 over time.

The controller 214 further generates display data 234-1 to 234-N, which specifies how the respective channels 202-1 to 202-N are to be controlled. The driver switching circuitry 212 routes the display data 234-1 to 234-N to a set of the amplifiers 218 that are in the enabled state 220. The amplifiers 218 in the enabled state 220 generate respective display signals (DS) 236-1, 236-2 . . . 236-N. The display signals 236 are passed to the outputs 216. Each display signal 236 has a voltage or a current that conveys the corresponding display data 234. The display signals 236 are provided to the ports 206 and are then passed to the channels 202. The display signals 236 can alternatively be referred to as drive signals. Example implementations of the driver switching circuitry 212 are further described with respect to FIGS. 3-1 and 3-2.

FIG. 3-1 illustrates a first portion of an example implementation of the driver switching circuitry 212. In the depicted configuration, the driver switching circuitry 212 includes multiplexers 224-1 to 224-M, where M represents a positive integer that is less than N. The variable M represents a quantity of sets of amplifiers 302 that are structured within the driver circuit 210. In this example, amplifiers 218-1 to 218-K represent a first set of amplifiers 302-1 and amplifiers 218-L to 218-N represent another set of amplifiers 302-M, where K and L are positive integers that are less than M and where L is greater than K. In some implementations, the amplifiers 218 that are included within a set 302 are amplifiers 218 that are positioned next to each other (e.g., neighboring amplifiers 218) to decrease routing complexity within the display driver integrated circuit 114. Other groupings of the amplifiers 218 are also possible, however.

The driver switching circuitry 212 also includes multiple switches 226. Although only two switches 226-(K−1) and 226-(N−M) are explicitly shown in FIG. 3-1 due to space constraints, the driver switching circuitry 212 can include more than two switches 226. In this example, the switches 226 are implemented as single-pole double-throw (SPDT) switches.

Each multiplexer 224 has an output that is coupled to one of the amplifiers 218 within the corresponding set of amplifiers 302. For example, the multiplexer 224-1 has an output that is coupled to an input of the amplifier 218-1. Likewise, the multiplexer 224-M has an output that is coupled to an input of the amplifier 218-L. The inputs of the other amplifiers 218 within the set of amplifiers 302 are coupled to a throw of a corresponding switch 226. For example, an input of the amplifier 218-K is coupled to a throw of the switch 226-(K−1). Likewise, an input of the amplifier 218-N is coupled to a throw of the switch 226-(N−M). The other throws of the switches 226 are coupled to an input of the corresponding multiplexers. For example, the other throw of the switch 226-(K−1) is coupled to an input of the multiplexer 224-1. Likewise, the other throw of the switch 226-(N−M) is coupled to an input of the multiplexer 224-M.

The controller 214 is coupled to the poles of the switches 226 and is coupled to one input of each of the multiplexers 224. During operation, the controller 214 passes the display data 234-1 and the display data 234-L to the input of the multiplexers 224-1 and 224-M, respectively. The controller 214 also passes the display data 234-K and the display data 234-N to the poles of the switches 226-(K−1) and 226-(N−M), respectively.

Other implementations are also possible in which the driver switching circuitry 212 does not include the switches 226. In this case, the controller 214 is directly coupled to all of the inputs of the multiplexers 224 as well as the inputs of the amplifiers 218. In this case, the controller 214 provides the display data 234-K to both the multiplexer 224-1 and the amplifier 218-K. Also, the controller 214 provides the display data 234-N to both the multiplexer 224-M and the amplifier 218-N.

Depending on a configuration 118 of the display driver integrated circuit 114, the switches 226 pass the corresponding display data 234 to inputs of the multiplexers 224 or pass the corresponding display data 234 to the corresponding amplifiers 218. The driver switching circuitry 212 can optionally include one or more demultiplexers 228, as further described with respect to FIG. 3-2.

FIG. 3-2 illustrates a second portion of an example implementation of the driver switching circuitry 212. In the depicted configuration, the driver switching circuitry 212 includes demultiplexers 228-1 to 228-M. An input of each of the demultiplexers 228 is coupled to one of the amplifiers 218 within the corresponding set of amplifiers 302. For example, an input of the demultiplexer 228-1 is coupled to the amplifier 218-1, and an input of the demultiplexer 228-M is coupled to the amplifier 218-L. In general, the input of a demultiplexer 228 is coupled to one of the amplifiers 218, within a set of amplifiers 302, that has an input coupled to a multiplexer 224 of FIG. 3-1. Outputs of the demultiplexer 228 are directly or indirectly coupled to a set of outputs 216 that correspond with the set of amplifiers 302. For example, the demultiplexer 228-1 has outputs coupled to the outputs 216-1 to 216-K, which correspond to the amplifiers 218-1 to 218-K within the first set 302-1. Likewise, the demultiplexer 228-M has outputs that are coupled to the outputs 216-L and 216-N, which correspond to the amplifiers 218-L to 218-N of the set 302-M.

The driver switching circuitry 212 also includes other switches 226, which are represented by switch 304-(K−1) and switch 304-(N−M). Although not explicitly shown in FIG. 3-2 due to space constraints, the driver switching circuitry 212 can include additional other switches 304. In this example, the switches 304 are implemented as single-pole double-throw switches. Each of the switches 304 has a pole that is coupled to a corresponding output 216, a first throw that is coupled to an output of a corresponding demultiplexer 228, and a second throw that is coupled to an output of a corresponding amplifier 218. For example, the switch 304-(K−1) has a pole that is coupled to the output 216-K, a first throw that is coupled to an output of the demultiplexer 228-1, and a second throw that is coupled to an output of the amplifier 218-K. Likewise, the switch 304-(N−M) has a pole that is coupled to the output 216-N, a first throw that is coupled to an output of the demultiplexer 228-M, and a second throw that is coupled to an output of the amplifier 218-N. Using the multiplexers 224 of FIG. 3-1 and the switches 226 of FIG. 3-1 and optionally using the demultiplexers 228 of FIG. 3-2 and the other switches 304 of FIG. 3-2, the display driver integrated circuit 114 can operate in different configurations 118, including a power-conserving configuration. The different configurations 118 of the display driver integrated circuit 114 are further described with respect to FIGS. 4 to 7.

FIG. 4 illustrates an example timing diagram 400 for operating the display driver integrated circuit 114 in a first configuration 118-1 based on the display panel 112 having a first refresh rate 116-1. In this example, the first refresh rate 116-1 represents the standard refresh rate (e.g., a highest refresh rate of the display panel 112). The first configuration 118-1 represents a standard configuration of the display driver integrated circuit 114. The standard configuration is a configuration 118 that consumes a highest amount of power by enabling all of the amplifiers 218 within the driver circuit 210.

At the bottom of FIG. 4, the display driver integrated circuit 114 is depicted with a set 302 of four amplifiers 218-1, 218-2, 218-3, and 218-4. The operations described with respect to this set 302 can generally apply to other sets 302 within the driver circuit 210. Although the set 302 is shown to include four amplifiers 218 in FIG. 4, other implementations are also possible in which the sets 302 of amplifiers include a different quantity of amplifiers 218, such as two, three, or six amplifiers 218. In general, increasing the quantity of amplifiers 218 within each set 302 increases the quantity of configurations 118, in particular power-saving configurations, that the display driver integrated circuit 114 can support. In accordance with the first configuration 118-1, all of the amplifiers 218 within the set 302 are in the enabled state 220.

To support the first configuration 118-1, the driver switching circuitry 212 routes the display data 234-1, 234-2, 234-3, and 234-4 to the amplifiers 218-1, 218-2, 218-3, and 218-4, respectively. During operation, the amplifiers 218-1, 218-2, 218-3, and 218-4 respectively generate the display signals 236-1, 236-2, 236-3, and 236-4. Each of the display signals 236 include the corresponding display data 234.

The timing diagram 400 depicts total emission 402 (TE 402) of the display panel 112 and line driving timing 404 (LD 404). The total emission 402 indicates the time period during which the pixels of the display panel 112 emit light in a single frame. It corresponds to a sum of the emission times of all of the rows within the display panel 112 being driven one by one. In other words, the total emission 402 includes the entire active emission period before the display refreshes again. A duration of each frame is represented by the frame interval 406. The frame interval 406 is equal to an inverse of the refresh rate 116-1. For example, if the first refresh rate 116-1 is 120 hertz, the frame interval 406 is equal to 8.3 milliseconds (ms).

The line driving timing 404 indicates intervals during which individual rows of pixels within the display panel 112 are activated during the display refresh cycle. The line driving timing 404 can also be referred to as the charging time. In this example the line driving timing interval is equal to 7.7 microseconds.

The timing diagram 400 also depicts example voltages or currents of the display signals 236 (DS 236). During the frame interval 406, the selection signal 232 has a state that causes the multiplexer 224 to route, to the amplifier 218 that is coupled to its output, the display data 234 that corresponds with that amplifier 218. This means that the driver switching circuitry 212 passes the display data 234-1 to a multiplexer 224, which then passes the display data 234-1 to the amplifier 218-1. Although not explicitly shown in FIG. 4, the configuration signal 230 can be appropriately generated to cause the switches 226 in FIG. 3-1 to route the corresponding display data 234 to the corresponding amplifier 218 instead of the corresponding multiplexer 224. Since all of the amplifiers 218 within the set 302 are in the enabled state 220, the first configuration 118-1 consumes the most amount of power compared to the power-conserving configurations 118, examples of which are further described with respect to FIGS. 5 to 7.

FIG. 5 illustrates a second example timing diagram 500 for operating the display driver integrated circuit 114 in a second configuration 118-2 based on the display panel 112 having a second refresh rate 116-2. The second refresh rate 116-2 corresponds to a power-efficient refresh rate. This means that the second refresh rate 116 is less than the first refresh rate 116-1. In this example, the second refresh rate 116-2 can be 60 hertz and the frame interval 406 of the total emissions 402 can be 16.67 milliseconds. The line driving timing 404 can have an interval of 15.4 microseconds. In this configuration 118-2, the line driving timing 404 is sub-divided into two time intervals to enable a display signal 236 to include two different types of display data 234. Since both the frame interval 406 and the interval of the line driving timing 404 are increased by a factor of 2, the overall charging time remains consistent with that used for the refresh rate 116-1 and the first configuration 118-1 of FIG. 4.

The second configuration 118-2 is an example power-conserving configuration. This means that a first subset of the amplifiers 218 within each set 302 are in the disabled state 222 and a second subset of the amplifiers 218 within each set 302 are in the enabled state 220. Since the second refresh rate 116-2 is equal to half of the first refresh rate 116-1 (e.g., the standard refresh rate), the second configuration 118-2 can enable half of the amplifiers 218 within each set 302 and can disable the remaining half of the amplifiers 218 within each set 302. In this example, the amplifiers 218-2 and 218-4 are in the disabled state 222 and the amplifiers 218-1 and 218-3 are in the enabled state 220.

To support the second configuration 118-2, the driver switching circuitry 212 routes, over time and in a serail manner, the display data 234-1 and 234-2 to the amplifier 218-1. As shown in the timing diagram 500, the selection signal 232 has a first state during a first half of the line driving timing interval to cause the display signal 236-1 to include the first display data 234-1, which is associated with the first channel 202-1. The selection signal 232 has a second state during a second half of the line driving timing interval to cause the display signal 236-1 to include the second display data 234-2, which is associated with the second channel 202-2.

The driver switching circuitry 212 also routes, over time and in a serial manner, the display data 234-3 and 234-4 to the amplifier 218-3. The first state of the selection signal 232 during the first half of the line driving timing interval causes the display signal 236-3 to include the third display data 234-3, which is associated with a third channel 202. The second state of the selection signal 232 during the second half of the line driving timing interval causes the display signal 236-3 to include the display data 234-4, which is associated with a fourth channel 202. Since the amplifiers 218-2 and 218-4 are in the disabled state 222, the display signals 236-2 and 236-4 do not contain any display data 234.

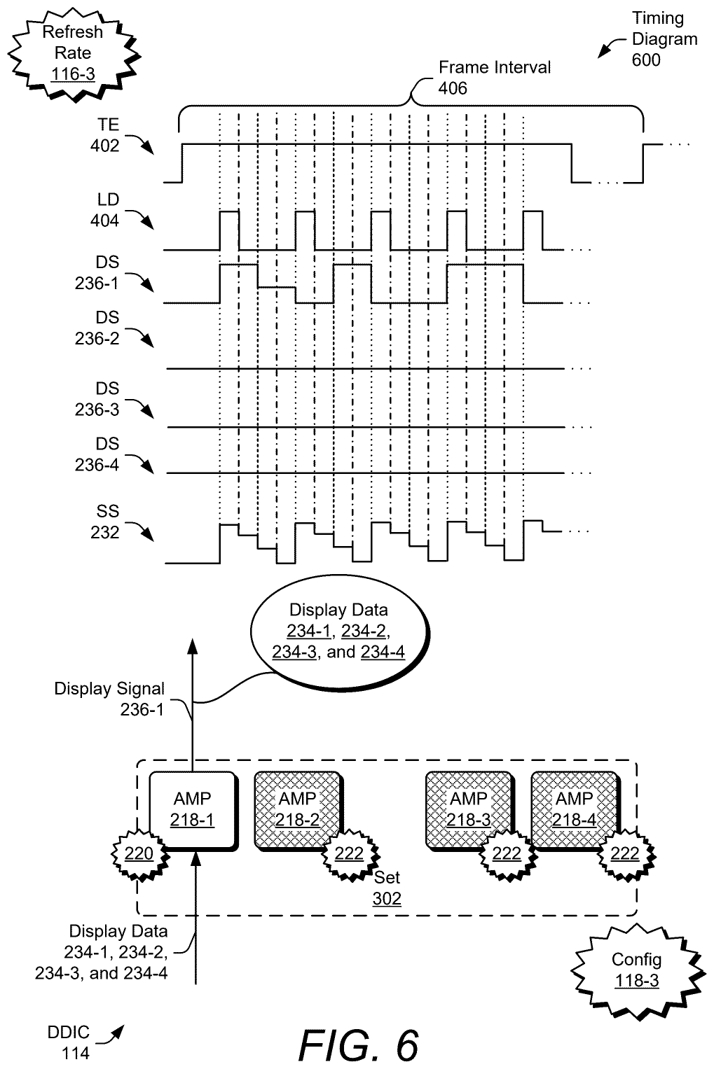

The amount of power consumed by the display driver integrated circuit 114 while in the second configuration 118-2 is less than the amount of power consumed while in the first configuration 118-1. This is because half of the amplifiers 218 are in the disabled state 222. For other refresh rates 116 that are lower than the second refresh rate 116, the display driver integrated circuit 114 can disable additional amplifiers 218 within each set 302, as further described with respect to FIG. 6.

FIG. 6 illustrates a third example timing diagram 600 for operating the display driver integrated circuit 114 in a third configuration 118-3 based on the display panel 112 having a third refresh rate 116-3. The third refresh rate 116-3 corresponds to another power-efficient refresh rate, which is lower than the second refresh rate 116-2. In this example, the third refresh rate 116-3 can be 30 hertz and the frame interval 406 of the total emissions 402 can be 33 milliseconds. The line driving timing 404 can have an interval of 30.8 microseconds. In this configuration 118-3, the line driving timing 404 is sub-divided into four time intervals to enable a display signal 236 to include four different types of display data 234. Since both the frame interval 406 and the interval of the line driving timing 404 are increased by a factor of 4, the overall charging time remains consistent with that used for the refresh rate 116-1 and the first configuration 118-1 of FIG. 4.

The third configuration 118-3 is another example power-conserving configuration. Since the third refresh rate 116-3 is equal to a quarter of the first refresh rate 116-1 (e.g., the standard refresh rate), the third configuration 118-3 can enable one quarter of the amplifiers 218 within each set 302 and can disable the remaining three-quarters of the amplifiers 218 within each set 302. In this example, the amplifiers 218-2, 218-3, and 218-4 are in the disabled state 222 and the amplifier 218-1 is in the enabled state 220.

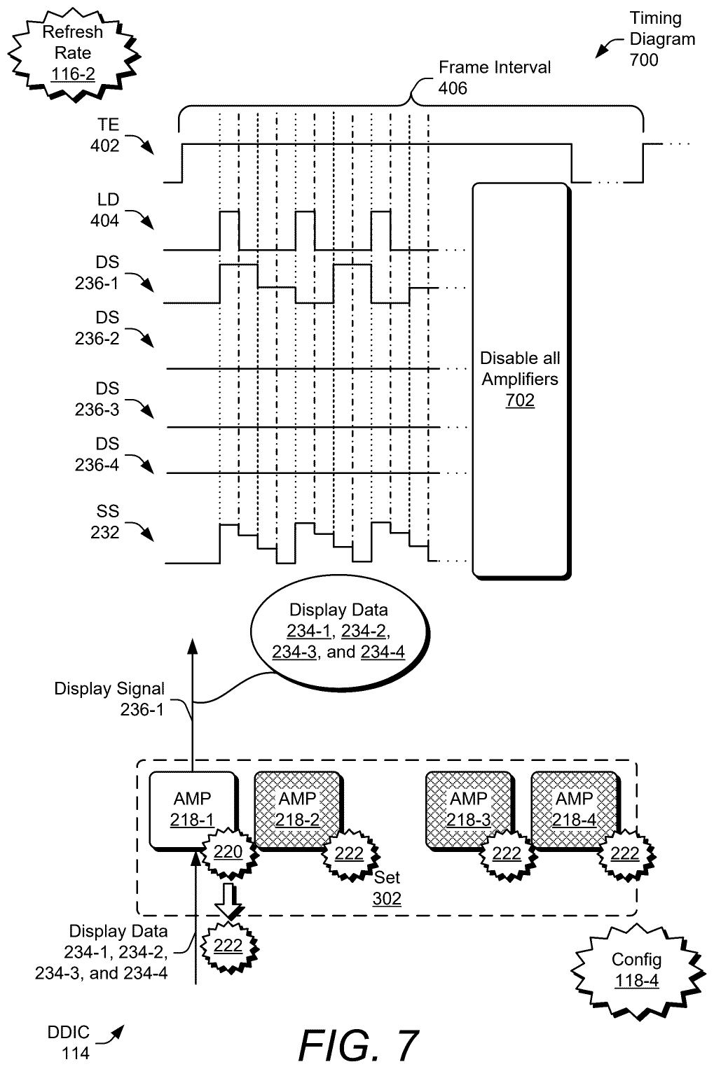

To support the third configuration 118-3, the driver switching circuitry 212 routes, over time and in a serial manner, the display data 234-1, 234-2, 234-3, and 234-4 to the amplifier 218-1. As shown in the timing diagram 600, the selection signal 232 has a first state during a first quarter of the line driving timing 404 to cause the display signal 236-1 to include the first display data 234-1. In more detail, the first state of the selection signal 232 causes the multiplexer 224 to pass the display data 234-1 to the amplifier 218-1. The selection signal 232 has a second state during a second quarter of the line driving timing 404 to cause the display signal 236-1 to include the second display data 234-2. In more detail, the second state of the selection signal 232 causes the multiplexer 224 to pass the display data 234-2 to the amplifier 218-1. During a third quarter of the line driving timing 404, the selection signal 232 has a third state to cause the display signal 236-1 to include the third display data 234-3. In more detail, the third state of the selection signal 232 causes the multiplexer 224 to pass the display data 234-3 to the amplifier 218-1. During a fourth quarter of the line driving timing 404, the selection signal 232 has a fourth state to cause the display signal 236-1 to include the fourth display data 234-4. In more detail, the fourth state of the selection signal 232 causes the multiplexer 224 to pass the display data 234-4 to the amplifier 218-1. For some refresh rates 116, the display driver integrated circuit 114 can disable all amplifiers 218 within each set 302 for a portion of the frame interval 406, as further described with respect to FIG. 7.

FIG. 7 illustrates a fourth example timing diagram 700 for operating the display driver integrated circuit 114 in a fourth configuration 118-4 based on the display panel 112 having a fourth refresh rate 116-4. The fourth refresh rate 116-4 represents yet another power-efficient refresh rate, which is less than the third refresh rate 116-3. In this example, the fourth refresh rate 116-4 can be 1 hertz and the frame interval 406 of the total emissions 402 can be one second. The interval of the line driving timing 404 is 30.8 microseconds, the same as in the third configuration 118-3 of FIG. 6.

The fourth configuration 118-4 is another example power-conserving configuration. During a first portion of the total emission 402, the display driver integrated circuit 114 operates in a same manner that is described with respect to the third configuration 118-3. This means that the amplifier 218-1 is in the enabled state and the amplifiers 218-2 to 218-4 are in the disabled state 222. Since the fourth refresh rate 116-4 enables all of the display data 234 associated with the set 302 to be communicated via the display signal 236-1 in a fraction of the frame interval 406 with the line driving timing 404 being the same as in the third configuration 118-3 of FIG. 6, the fourth configuration 118-4 disables all the amplifiers at 702 during a second portion of the frame interval 406. This means that the amplifier 218-1, which was enabled during a first portion of the frame interval 406, is disabled during the second portion of the frame interval 406. This enables the display driver integrated circuit 114 to consume less power compared to the amount of power consumed in the second configuration 118-2 or the third configuration 118-3.

### CONCLUSION

Although techniques using, and apparatuses including, a display driver integrated circuit with a power-conserving configuration have been described in language specific to features and/or methods, it is to be understood that the subject of the appended claims is not necessarily limited to the specific features or methods described. Rather, the specific features and methods are disclosed as example implementations of a display driver integrated circuit with a power-conserving configuration.

What is claimed is:

1. An apparatus comprising:
a display driver integrated circuit configured to:
be coupled to a display panel, the display panel capable of supporting different refresh rates, the different refresh rates comprising at least a standard refresh rate and a first power-efficient refresh rate, the first power-efficient refresh rate being less than the standard refresh rate;
based on the display panel having the standard refresh rate, operate in a first configuration to generate at least two display signals using at least two amplifiers, the at least two display signals comprising different display data associated with different channels of the display panel; and
based on the display panel having the first power-efficient refresh rate, operate in a second configuration to generate a first display signal of the at least two display signals using a first amplifier of the at least two amplifiers, the first display signal comprising the different display data associated with the different channels.

2. The apparatus of claim 1, wherein the display driver integrated circuit is configured to:
consume a first amount of power in the first configuration; and
consume a second amount of power in the second configuration, the second amount of power being less than the first amount of power.

3. The apparatus of claim 1, wherein the display driver integrated circuit comprises:
at least one driver circuit comprising:
the first amplifier configured to be in an enabled state based on the display driver integrated circuit being in the first configuration or based on the display driver integrated circuit being in the second configuration;
a second amplifier configured to be in the enabled state based on the display driver integrated circuit being in the first configuration or be in a disabled state based on the display driver integrated circuit being in the second configuration.

4. The apparatus of claim 3, wherein the display driver integrated circuit comprises driver switching circuitry configured to selectively:
based on the display driver integrated circuit being in the first configuration, route first display data of the different display data to the first amplifier and route second display data of the different display data to the second amplifier; and
based on the display driver integrated circuit being in the second configuration, route the first display data to the first amplifier during a first time interval and route the second display data to the first amplifier during a second time interval.

5. The apparatus of claim 4, wherein:
the display driver integrated circuit is configured to:
be coupled to a first port of the display panel via a first output of the display driver integrated circuit, the first port associated with a first channel of the different channels; and
be coupled to a second port of the display panel via a second output of the display driver integrated circuit, the second port associated with a second channel of the different channels; and
the driver switching circuitry is configured to selectively:
based on the display driver integrated circuit being in the first configuration:
route a first display signal of the at least two display signals from the first amplifier to the first output of the display driver integrated circuit; and
route a second display signal of the at least two display signals from the second amplifier to the second output of the display driver integrated circuit; and
based on the display driver integrated circuit being in the second configuration:
route the first display signal from the first amplifier to the first output of the display driver integrated circuit during the first time interval; and
route the first display signal from the first amplifier to the second output of the display driver integrated circuit during the second time interval.

6. The apparatus of claim 4, wherein:
the display driver integrated circuit is configured to:
be coupled to a first port of the display panel via a first output of the display driver integrated circuit, the first port associated with a first channel of the different channels;
be coupled to a second port of the display panel via a second output of the display driver integrated circuit, the second port associated with a second channel of the different channels;
pass the first display signal from the first amplifier to the first output based on the display driver integrated circuit being in the first configuration or the second configuration; and
pass a second display signal of the at least two display signals from the second amplifier to the second output based on the display driver integrated circuit being in the first configuration.

7. The apparatus of claim 4, wherein:
the different refresh rates further comprise a second power-efficient refresh rate, the second power-efficient refresh rate being less than the first power-efficient refresh rate;
this display driver integrated circuit is configured to:
based on the display panel having the standard refresh rate, operate in the first configuration to generate at least four display signals using at least four amplifiers, the at least four display signals respectively comprising the different display data associated with at least four of the different channels;
based on the display panel having the first power-efficient refresh rate, operate in the second configuration to generate the first display signal of the at least four display signals using the first amplifier of the at least four amplifiers and generate a third display signal of the at least four display signals using a third amplifier of the at least four amplifiers, the first display signal comprising the different display data associated with a first pair of the different channels, the third display signal comprising the different display data associated with a second pair of the different channels; and
based on the display panel having the second power-efficient refresh rate, operate in a third configuration to generate the first display signal of the at least four display signals using a first amplifier of the at least four amplifiers, the first display signal comprising the different display data associated with the at least four of the different channels; and
the at least one driver circuit comprises:
the first amplifier configured to be in the enabled state based on the display driver integrated circuit being in the first configuration, based on the display driver integrated circuit being in the second configuration, or based on the display driver integrated circuit being in the third configuration;
the second amplifier configured to be in the enabled state based on the display driver integrated circuit being in the first configuration, be in the disabled state based on the display driver integrated circuit being in the second configuration, or be in the disabled state based on the display driver integrated circuit being in the third configuration;
the third amplifier configured to be in the enabled state based on the display driver integrated circuit being in the first configuration, be in the enabled state based on the display driver integrated circuit being in the second configuration, and be in the disabled state based on the display driver integrated circuit being in the third configuration; and
a fourth amplifier configured to be in the enabled state based on the display driver integrated circuit being in the first configuration, be in the disabled state based on the display driver integrated circuit being in the second configuration, and be in the disabled state based on the display driver integrated circuit being in the third configuration.

8. The apparatus of claim 7, wherein:
the first power-efficient refresh rate is half the standard refresh rate; and
the second power-efficient refresh rate is half the first power-efficient refresh rate.

9. The apparatus of claim 8, wherein:
the standard refresh rate is 120 hertz;
the first power-efficient refresh rate is 60 hertz; and
the second power-efficient refresh rate is 30 hertz.

10. The apparatus of claim 7, wherein:
the different refresh rates further comprise a third power-efficient refresh rate, the third power-efficient refresh rate being less than the second power-efficient refresh rate;
the display driver integrated circuit is configured to, based on the display panel having the third power-efficient refresh rate, operate in a fourth configuration to:
generate, during a first portion of a total emission time interval, the first display signal of the at least four display signals using the first amplifier of the at least four amplifiers, the first display signal comprising the different display data associated with the at least four of the different channels; and
disable the at least four amplifiers during a second portion of the total emission time interval.

11. The apparatus of claim 10, wherein the third power-efficient refresh rate is 1 hertz.
